(19) United States
(12) Patent Application Publication
(10) Pub. No.: US 2014/0060130 A1
(43) Pub. Date: Mar. 6, 2014

(54) PROCESSES AND SYSTEMS FOR CO-PRODUCING FERMENTATION PRODUCTS, FERTILIZERS, AND DISTILLERS GRAINS FROM STARCH-CONTAINING FEEDSTOCKS, AND COMPOSITIONS PRODUCED THEREFROM

(71) Applicant: Ian PURTLE, Plymouth, MN (US)

(72) Inventor: Ian PURTLE, Plymouth, MN (US)

(21) Appl. No.: 14/014,706

(22) Filed: Aug. 30, 2013

Related U.S. Application Data
(60) Provisional application No. 61/696,975, filed on Sep. 5, 2012.

(51) Int. Cl. C05B 17/00; C05C 11/00; C05F 5/00

(52) U.S. Cl. CPC C05B 17/00; C05F 5/008; C05C 11/00
USPC 71/23

(57) ABSTRACT

The present invention provides a process for producing a fertilizer composition from still bottoms obtained from milling of a starch-containing feedstock (such as corn), comprising separating still bottoms into a solids stream and a thin stillage stream; removing water to generate a condensed distillers solubles stream; and recovering the condensed distillers solubles stream as a fertilizer composition. Novel fertilizer compositions as well as novel distillers grains products are co-produced with a fermentation product (such as ethanol or isobutanol). Benefits include the ability to recycle valuable crop nutrients in a sustainable manner; improved ethanol life cycle analysis due to lower crop inputs and lower energy consumption; reduced environmental burden from industrial animal farming due to nitrogen and phosphorous emissions; higher consumption of distillers grains in ruminants currently limited by sulfur and/or fat inhibition; and higher consumption of distillers grains in monogastrics due to higher protein digestibility and less heat damage.

### PRIORITY DATA

This patent application claims priority to U.S. Provisional Patent App. No. 61/696,975, filed Sep. 5, 2012, which is hereby incorporated by reference herein in its entirety.

### FIELD OF THE INVENTION

The present invention generally relates to processes, systems, and apparatus for the conversion of corn or other starch-containing feedstocks into fermentable sugars (or fermentation products), fertilizers, distillers grains, and other co-products.

### BACKGROUND OF THE INVENTION

The world has a limited supply of accessible phosphorus reserves concentrated in only a few countries. Increasingly, countries are defending their own supplies to avoid shortage by reducing exports. The U.S. has approximately 40 years of reserves of phosphate rock at current domestic consumption levels.

The availability of crop nutrients is a key factor in being able to boost and sustain agronomic productivity. For example, U.S. corn yields have increased from an average of around 40 bushels per acre in the early 1950s to around 160 bushels per acre in this decade. The availability and application of fertilizers, including phosphorus-containing fertilizer, has played a key role in achieving this level of yield increase.

In order to continue to improve agronomic productivity (yield improvement) to feed a growing population, projected to reach 9 billion people by 2050, it is critical that we start to conserve our limited phosphorus reserves by recycling phosphorus emissions back as a crop nutrient.

Ethanol faces criticism for the amount of energy required for its production. Fertilizer production for corn requires a significant energy input. The ability to recover and recycle the crop nutrient components of dried distillers grains with solubles (DDGS) products would reduce the need to apply new fertilizer (N, P, K, and S) significantly, indirectly lowering the energy demand and thus improving the overall environmental sustainability for growing corn.

In corn dry milling, the drying process of the co-products is a significant expense. The energy cost of drying DDGS is the largest single cost in producing ethanol and isobutanol after the cost of corn itself. By removing condensed distillers solubles (CDS) from the DDGS stream to be dried, that co-product drying cost would be reduced.

The U.S. corn-derived ethanol industry is facing difficulties in domestic and export markets as stricter rules on carbon life-cycle assessments of fuels are adopted. Such regulations are those set forth by the Californian Air Resources Board and the European Union's Renewable Energy Directive.

Excess nitrogen and phosphorus in our ecosystem has a negative effect on our water systems. Run-off from crop and industrial animal farming in the U.S. Midwest has contributed significantly to the hypoxic dead-zone in the Gulf of Mexico at the Mississippi Delta. DDGS being fed to animals, particularly ruminant animals, has a much higher concentration of phosphorus than corn itself. The amount of phosphorus fed to the ruminant animals in the DDGS far exceeds their biological need. The excess phosphorus is passed to the environment in the urine and feces.

The U.S. remains committed to politically and financially supporting efforts in the areas of rural job growth and the reduction in dependence on foreign oil. The profitability of the U.S. corn farming industry is a key element is achieving these objectives.

Currently about 40% of U.S. corn production is consumed by the fuel ethanol industry. However, after taking credit for the DDGS returned to the animal feed industry, displacing corn and soybean meal, the net effective direct corn usage loss to ethanol production is estimated at only 16%.

Improvements in corn milling, including corn dry milling, are therefore needed commercially to address the above-mentioned needs. There is much interest to reduce the energy use and greenhouse-gas emissions associated with producing fuel ethanol and isobutanol from corn, overall the entire life cycle from corn growing to final fuel use. Such improvements will be applicable not only to corn but also to any other starch-containing fermentation feedstocks. Other benefits may include extension of U.S. phosphorus reserves, increased access to ethanol export markets, continued growth of both corn and ethanol production, reduced phosphorous emissions from industrial animal farming, rural jobs, and reduced dependence on imported petroleum.

### SUMMARY OF THE INVENTION

In some variations, this invention provides a process for producing a fertilizer composition from still bottoms obtained from milling of a starch-containing feedstock, the process comprising:

(a) providing or receiving a solids-rich still bottoms obtained from a distillation unit configured for purifying a fermentation product derived from glucose obtained during the milling;

(b) separating the still bottoms into a still bottoms solids stream and a thin stillage stream;

(c) removing a portion of the water contained in the thin stillage stream, thereby generating a condensed distillers solubles stream; and

(d) recovering at least a portion of the condensed distillers solubles stream as a fertilizer composition.

The starch-containing feedstock may be selected from the group consisting of corn, wheat, cassaya, rice, potato, millet, sorghum, and combinations thereof, for example. In some embodiments, the starch-containing feedstock is corn.

The fermentation product may be selected from the group consisting of ethanol, acetone, isopropanol, isobutanol, 1-butanol, and combinations thereof. Other fermentation products are of course possible.

In some embodiments, step (c) removes at least about 10% of the water contained in the thin stillage stream, such as 50% or more of the water contained in the thin stillage stream. Prior to water removal, the process optionally also includes recovering oil from the thin stillage stream, such as by centrifugation.

The fertilizer composition that is produced in step (d) may contain nitrogen, phosphorous, and potassium. In some embodiments, the fertilizer composition is dried to produce a more-concentrated fertilizer composition. In some embodiments, at least a portion of the condensed distillers solubles stream is dried in combination with another source of nutrient-containing solids.

In some embodiments of the invention, an additional source of nitrogen is introduced to the fertilizer composition, wherein the additional source of nitrogen is not derived from the condensed distillers solubles stream. Likewise, in some embodiments, an additional source of phosphorous is introduced to the fertilizer composition, wherein the additional source of phosphorous is not derived from the condensed distillers solubles stream. Also, an additional source of potassium may be introduced to the fertilizer composition, wherein the additional source of potassium is not derived from the condensed distillers solubles stream. An additional source of sulfur may also be introduced to the fertilizer composition, wherein the additional source of sulfur is not derived from the condensed distillers solubles stream. The additional source for any of these (N, P, K, and/or S) may be derived from a residue associated with the starch-containing feedstock, such as corn stover associated with corn feedstock.

In addition to producing a fertilizer composition, the process may further comprise dewatering and/or drying at least a portion of the still bottoms solids stream to produce a distillers grains product, which may be dry distillers grains or wet distillers grains, or a combination of such products. In some embodiments, the distillers grains product contains less than about 0.4 wt % phosphorous on a dry basis. In some embodiments, the distillers grains product contains less than about 0.4 wt % potassium on a dry basis. In some embodiments, the distillers grains product contains less than about 0.5 wt % sulfur on a dry basis.

Some embodiments provide a process for producing a distillers grains product from still bottoms obtained from milling of a starch-containing feedstock, the process comprising:

(a) providing or receiving a solids-rich still bottoms obtained from a distillation unit configured for purifying a fermentation product derived from glucose obtained during the milling;

(b) separating the still bottoms into a still bottoms solids stream and a thin stillage stream;

(c) removing a portion of the water contained in the thin stillage stream, thereby generating a condensed distillers solubles stream;

(d) recovering at least a portion of the condensed distillers solubles stream; and

(e) dewatering and/or drying at least a portion of the still bottoms solids stream to produce a distillers grains product.

### BRIEF DESCRIPTION OF THE FIGURE

FIG. 1 is a block flow diagram depicting some embodiments of the invention, where dotted lines indicate optional streams and units.

These and other embodiments, features, and advantages of the present invention will become more apparent to those skilled in the art when taken with reference to the following detailed description of the invention.

### DETAILED DESCRIPTION OF EMBODIMENTS OF THE INVENTION

Certain embodiments of the present invention will now be further described in more detail, in a manner that enables the claimed invention so that a person of ordinary skill in this art can make and use the present invention.

Unless otherwise indicated, all numbers expressing reaction conditions, concentrations, yields, and so forth used in the specification and claims are to be understood as being modified in all instances by the term “about.” Accordingly, unless indicated to the contrary, the numerical parameters set forth in the following specification and attached claims are approximations that may vary depending at least upon the specific analytical technique. Any numerical value inherently contains certain errors necessarily resulting from the standard deviation found in its respective testing measurements.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs. If a definition set forth in this section is contrary to or otherwise inconsistent with a definition set forth in patents, published patent applications, and other publications that are incorporated by reference, the definition set forth in this specification prevails over the definition that is incorporated herein by reference.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”.

Some variations of the invention are premised on the realization that condensed distillers solubles (CDS) may be recovered and recycled as a fertilizer or a fertilizer component, to reduce the need for application of new fertilizers. The phosphorus (P) in corn, for example, is highly bioavailable. About 80% of the phosphorus in corn kernels ends up in the CDS, along with much of the nitrogen in water-soluble protein. Adding the CDS back to the stillage-derived solids overloads that material with bioavailable P. This is the source of a major environmental problem with P discharge in the manure of species fed DDGS (dry distillers grains with solubles).

Some variations are further premised on the recognition, heretofore unappreciated, that such methods will concurrently lower the amount of energy necessary to dry the stillage for producing a distillers grains co-product. The required energy will be reduced since there is less mass of solids to be dried, if the CDS is not added back to the stillage-derived solids. CDS is also known as syrup or evaporated thin stillage.

Taken together, the above two factors are expected to significantly reduce the greenhouse-gas emissions for producing fuel ethanol (or other products) from starch-containing feedstocks.

In some variations, this invention provides a process for producing a fertilizer composition from still bottoms obtained from milling of a starch-containing feedstock, the process comprising:

(a) providing or receiving a solids-rich still bottoms obtained from a distillation unit configured for purifying a fermentation product derived from glucose obtained during the milling;

(b) separating the still bottoms into a still bottoms solids stream and a thin stillage stream;

(c) removing a portion of the water contained in the thin stillage stream, thereby generating a condensed distillers solubles stream; and

(d) recovering at least a portion of the condensed distillers solubles stream as a fertilizer composition.

The starch-containing feedstock may be selected from the group consisting of corn, wheat, cassaya, rice, potato, millet, sorghum, and combinations thereof, for example. In some embodiments, the starch-containing feedstock is corn. Any other feedstock or feedstock mixture that contains at least some starch or other form of glucose units joined by glycosidic bonds, may be utilized. Mixtures of starch-containing feedstocks with cellulosic feedstocks, for example, may be used.

The fermentation product may be selected from the group consisting of ethanol, acetone, isopropanol, isobutanol, 1-butanol, and combinations thereof. Mixtures may be produced, such as in ABE fermentation which ferments glucose to a mixture of acetone, 1-butanol (n-butanol), and ethanol. Other fermentation products are of course possible. The fermentation product need not be a fuel; for example, organic acids may be produced for chemical and material uses.

Step (c) preferably removes at least about 10%, such as 50% or more, of the water contained in the thin stillage stream.

Prior to water removal from the thin stillage, an oil co-product may be recovered by using centrifugation or another suitable separation technique. For example, when the feedstock is corn, industrial crude corn oil may be produced. Crude corn oil may optionally be recovered from thin stillage produced from the liquid phase of the bottoms from the distillation column by applying the well-known practice of separating oil from an aqueous stream using a disc centrifuge. The corn germ oil quality of this stream is typically only suitable for industrial applications. It is noted that in preferred embodiments, corn fractionation removes most of the oil with the germ. Thus, there typically would not be a large amount of oil to recover as industrial crude corn oil.

The fertilizer composition that is produced may contain nitrogen (N), phosphorous (P), and potassium (K), in various amounts. In some embodiments, the fertilizer composition contains from about 1 wt % to about 10 wt % nitrogen, such as about 2 wt % to about 6 wt % nitrogen (elemental basis). In some embodiments, the fertilizer composition contains from about 0.5 wt % to about 5 wt %, such as about 1 wt % to about 2 wt % phosphorous (elemental basis). In some embodiments, the fertilizer composition contains from about 0.5 wt % to about 5 wt %, such as 2 wt % potassium (elemental basis). The fertilizer composition may contain less than or greater than any of these ranges for N, P, and K, in certain embodiments.

The fertilizer composition may also contain sulfur (S). For example, the fertilizer composition may contain up to about 3 wt % sulfur, such as about 0.1 wt % to about 2 wt % sulfur (elemental basis).

The fertilizer composition may be dried, at least partially, to produce a more-concentrated fertilizer composition. The fertilizer composition may be in liquid form (i.e. completely dissolved solids), or in slurry form (i.e., suspended solids with possibly dissolved solids).

In some embodiments, at least a portion of the condensed distillers solubles stream is dried in combination with another source of nutrient-containing solids.

In some embodiments of the invention, an additional source of nitrogen is introduced to the fertilizer composition, wherein the additional source of nitrogen is not derived from the condensed distillers solubles stream. Additional sources of nitrogen include, but are by no means limited to, ammonia, ammonium salts, nitrates, urea, and combinations thereof (e.g., urea-ammonium nitrate).

Likewise, in some embodiments, an additional source of phosphorous is introduced to the fertilizer composition, wherein the additional source of phosphorous is not derived from the condensed distillers solubles stream. Additional sources of phosphorous include, but are by no means limited to, phosphoric acid, phosphates, phytates, phosphorus pentoxide, manure, and combinations thereof.

Also, an additional source of potassium may be introduced to the fertilizer composition, wherein the additional source of potassium is not derived from the condensed distillers solubles stream. Additional sources of potassium include, but are by no means limited to, potash, potassium chloride, potassium sulfate, potassium carbonate, potassium oxide, and combinations thereof.

An additional source of sulfur may also be introduced to the fertilizer composition, wherein the additional source of sulfur is not derived from the condensed distillers solubles stream. Additional sources of sulfur include, but are by no means limited to, elemental sulfur, sulfates, sulfites, sulfurous acid, gypsum, polysulfides, thiosulfates, and combinations thereof.

The additional source for any of these (N, P, K, or S) may be derived from a residue associated with the starch-containing feedstock, or another feedstock. For example, the additional source may be derived from corn stover, whether or not the selected starch-containing feedstock is corn. This may be an attractive option in particular for potassium, since approximately two-thirds of the potassium fertilizer that is taken up during corn growing ultimately ends up in the corn stover.

Optionally, a portion of the condensed distillers solubles stream may be dried in combination with the still bottoms solids. For example, the fraction of the CDS stream that is dried with the still bottoms solids, rather than being recovered as a fertilizer, may be about 0, about 50%, or about 90%.

The process may further comprise drying at least a portion of the still bottoms solids stream to produce a distillers grains product, which may be dry distillers grains (DDG) or wet distillers grains (WDG), or a combination of such products.

Some embodiments provide a process for producing a distillers grains product from still bottoms obtained from milling of a starch-containing feedstock, the process comprising:

(a) providing or receiving a solids-rich still bottoms obtained from a distillation unit configured for purifying a fermentation product derived from glucose obtained during the milling;

(b) separating the still bottoms into a still bottoms solids stream and a thin stillage stream;

(c) removing a portion of the water contained in the thin stillage stream, thereby generating a condensed distillers solubles stream;

(d) recovering at least a portion of the condensed distillers solubles stream; and

(e) dewatering and/or drying at least a portion of the still bottoms solids stream to produce a distillers grains product.

In some embodiments, the distillers grains product contains less than about 0.4 wt % phosphorous, less than about 0.4 wt % potassium, and less than about 0.5 wt % sulfur on a dry basis.

In some variations of this invention, a process for producing a glucose-fermentation product and a fertilizer composition from a starch-containing feedstock comprises the following steps:

(a) introducing the starch-containing feedstock to a fractionation unit configured to substantially remove the non-starch components, to generate a starch stream;

(b) introducing at least a portion of the starch stream, in the form of an aqueous slurry, to a saccharification unit configured to hydrolyze the starch into glucose;

(c) introducing at least a portion of the glucose to an aqueous fermentor containing a microorganism to ferment glucose into a dilute fermentation product;

(d) introducing the dilute fermentation product to a distillation unit configured to generate a purified fermentation product overhead and a solids-rich still bottoms;

(e) separating the still bottoms into a still bottoms solids stream and a thin stillage stream;

(f) optionally recovering oil from the thin stillage stream;

(g) removing a portion of the water contained in the thin stillage stream, thereby generating a condensed distillers solubles stream; and

(h) recovering at least a portion of the condensed distillers solubles stream as a fertilizer composition.

The starch-containing feedstock may be selected from the group consisting of corn, wheat, cassaya, rice, potato, millet, sorghum, and combinations thereof, for example. In some embodiments, the starch-containing feedstock is corn.

The fermentation product may be selected from the group consisting of ethanol, acetone, isopropanol, isobutanol, 1-butanol, and combinations thereof. Other fermentation products are of course possible, as explained above.

Certain embodiments utilize corn and produce ethanol, along with co-products including a fertilizer composition and a distillers grains product. Since ethanol production involves the conversion of the starch component of the corn kernel to ethanol, it is desirable to remove as much of the non-starch components of the corn kernel as is practically and economically possible prior to the saccharification/fermentation of the remaining endosperm.

Any known corn-fractionation method may be employed. The corn may be mildly steeped (tempered) prior to fractionation. Preferably, the fractionation unit is configured to substantially separate the germ and the bran from the endosperm, to generate a starch stream containing at least 95% of the starch contained in the starting corn.

The co-product streams created by fractionation of the corn are bran and germ. The bran is rich in fiber, such as about 60-75 wt % fiber. Removal of these two low-starch fractions significantly reduces the non-reactive biomass load on the downstream ethanol production process, particularly in the fermentors, the distillation column, and the distillers grains dryer.

At least part of the starch stream is conveyed, in the form of an aqueous slurry, to a saccharification unit configured to hydrolyze the starch into glucose. The glucose is introduced, either directly or after some period of storage, to an aqueous fermentor containing a microorganism to ferment glucose into dilute ethanol and carbon dioxide. In other embodiments, the fermentation product is a different fuel alcohol, such as isobutanol, or another fermentation product.

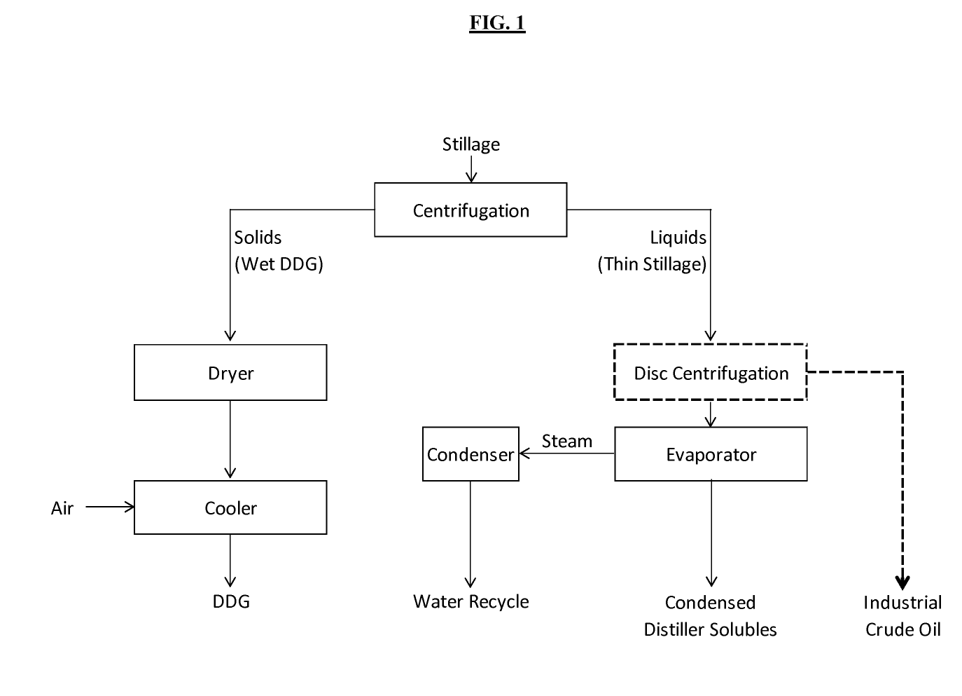

Dilute ethanol is produced from fermentation and introduced to a distillation unit configured to generate an ethanol-rich overhead and a solids-rich still bottoms. The ethanol-rich overhead is sent to an ethanol drying unit, such as molecular sieves, configured to generate anhydrous ethanol Anhydrous alcohol refers to fuel ethanol with a low water content, such as about 1 vol % or less. The solids-rich still bottoms are processed according to FIG. 1, for example, to produce a fertilizer composition as well as a distillers grains product.

The fertilizer composition that is produced in step (h) may contain nitrogen, phosphorous, and potassium. In some embodiments, the fertilizer composition is dried to produce a concentrated fertilizer composition.

The process may further comprise drying at least a portion of the still bottoms solids stream to produce a distillers grains product, which may be dry distillers grains or wet distillers grains, or a combination of such products.

Engineering optimization can be conducted to achieve energy integration. For example, energy requirements can be reduced by combining portions of streams from individual processes into a single unit. Various levels of heat recovery can be employed to meet drying requirements, for example.

The invention also provides products and compositions. In some variations, a liquid fertilizer product comprises a concentrated fertilizer composition produced by a process as disclosed. In some variations, a slurry fertilizer product comprises a concentrated fertilizer composition produced by a process as disclosed. In some variations, a solid fertilizer product comprises a concentrated fertilizer composition produced by a process as disclosed.

In some variations, a distillers grains product is produced by a process as disclosed in various embodiments. In some embodiments, the distillers grains product is characterized by one or more of the following properties: about 25% to 35% crude protein; about 8% to 10% fat; a Neutral Detergent Fiber value from about 40 to 44; and an Acid Detergent Fiber value from about 18 to 21.

The invention additionally provides several methods of use. In some variations, a method of using a fertilizer composition produced by a disclosed process comprises applying the fertilizer composition onto land operable to grow the starch-containing feedstock, thereby recycling fertilizers to soil on that land. The process may be repeated annually.

In some variations, a method of using a fertilizer composition produced by a disclosed process comprises selling, distributing, or otherwise providing the fertilizer composition to a selected market or geographic region, to enable a sustainable life cycle for fertilizing the growth of the starch-containing feedstock. The selected market or geographic region may be a single farm, plurality of farms, city, county, state, or region within a country (such as the Midwest of the United States).

In some variations, a method of using a distillers grains product produced by a disclosed process reduces the environmental burden from industrial animal farming due to nitrogen and phosphorous emissions. Because the distillers grains product provided herein has relatively low concentrations of nitrogen and phosphorous, there is less or no excess N and P that could otherwise run off the land into water sources or be emitted directly to the atmosphere.

In some variations, a method of using a distillers grains product produced by a disclosed process enables higher consumption of distillers grains in ruminants that are limited by sulfur inhibition. Because the distillers grains product provided herein has relatively low concentrations of sulfur, higher quantities of the distillers grains may be digested by ruminants such as cattle, goats, sheep, and bison. Sulfur is reduced to sulfide after entering the rumen, which then forms hydrogen sulfide, a neurotoxic gas. Hydrogen sulfide accumulates in the ruminal gas cap and is eructated by the animal. Upon re-inhalation, hydrogen sulfide gas is absorbed into the blood stream where it elicits a number of neurological effects.

In some variations, a method of using a distillers grains product produced by a disclosed process enables higher consumption of distillers grains in ruminants that are limited by fat intake. When lipids are included in ruminant diets, fermentation can be disrupted and the digestibility of nonlipid energy sources can be reduced. Dietary fat is more detrimental to the digestibility of structural carbohydrates than nonstructural carbohydrates. The lipid content of distillers co-products today is largely comprised of corn oil, which is high in unsaturated fats which inhibit microbial fermentation to a greater extent than saturated fatty acids.

In some variations, a method of using a distillers grains product produced by a disclosed process promotes high consumption of distillers grains in monogastrics (such as pigs) due to good protein (amino acid) digestibility and low heat damage associated with the distillers grains product. By not adding the CDS back to the solids, the Maillard reaction is reduced in the dryer, which thereby reduces heat damage and color formation in the distillers grains product.

Generally, the following benefits may be realized in some embodiments of the invention which remove CDS from distillers grains using the disclosed methods:

(a) Recycle valuable crop nutrients in a sustainable manner;

(b) Improved ethanol life cycle analysis (LCA) due to lower crop inputs and lower energy consumption;

(c) Better ethanol LCA enables industry expansion to export markets;

(d) Reduced environmental burden from industrial animal farming due to nitrogen and phosphorous emissions;

(e) Higher consumption of DDG in ruminants currently limited by sulfur and/or fat inhibition; and

(f) Higher consumption of DDG in monogastrics due to higher protein digestibility and less heat damage.

All publications, patents, and patent applications cited in this specification are incorporated herein by reference in their entirety as if each publication, patent, or patent application was specifically and individually put forth herein.

In this detailed description, reference has been made to multiple embodiments of the invention and non-limiting examples relating to how the invention can be understood and practiced. Other embodiments that do not provide all of the features and advantages set forth herein may be utilized, without departing from the spirit and scope of the present invention. This invention incorporates routine experimentation and optimization of the methods and systems described herein. Such modifications and variations are considered to be within the scope of the invention defined by the claims.

Where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially.

Therefore, to the extent that there are variations of the invention, which are within the spirit of the disclosure or equivalent to the inventions found in the appended claims, it is the intent that this patent will cover those variations as well. The present invention shall only be limited by what is claimed.

### REFERENCES

Liu, KeShun and Kurt A. Rosentrater. Distillers Grains: Production, Properties, and Utilization, CRC Press, Boca Raton, 2012.
Spiehs, M. J. et al. Journal of Animal Science, 80, 2639-2645, 2002.
Loy, D., “Ethanol coproducts for cattle the process and products,” Ames, IA: Iowa State University, University Extension, 2008.
Tjardes, K. and C. Wright, “Feeding corn distiller's coproducts to beef cattle,” 2002.

What is claimed is:

1. A process for producing a fertilizer composition from still bottoms obtained from milling of a starch-containing feedstock, said process comprising:
(a) providing or receiving a solids-rich still bottoms obtained from a distillation unit configured for purifying a fermentation product derived from glucose obtained during said milling;
(b) separating said still bottoms into a still bottoms solids stream and a thin stillage stream;
(c) removing a portion of the water contained in said thin stillage stream, thereby generating a condensed distillers solubles stream; and
(d) recovering at least a portion of said condensed distillers solubles stream as a fertilizer composition.

2. The process of claim 1, wherein said starch-containing feedstock is selected from the group consisting of corn, wheat, cassaya, rice, potato, millet, sorghum, and combinations thereof.

3. The process of claim 2, wherein said starch-containing feedstock is corn.

4. The process of claim 1, wherein said fermentation product is selected from the group consisting of ethanol, acetone, isopropanol, isobutanol, 1-butanol, and combinations thereof.

5. The process of claim 1, wherein step (c) removes at least about 10% of said water contained in said thin stillage stream.

6. The process of claim 1, wherein said fertilizer composition comprises nitrogen, phosphorous, and potassium.

7. The process of claim 6, wherein said fertilizer composition further comprises sulfur.

8. The process of claim 1, wherein an additional source of nitrogen is introduced to said fertilizer composition, wherein said additional source of nitrogen is not derived from said condensed distillers solubles stream.

9. The process of claim 1, wherein an additional source of phosphorous is introduced to said fertilizer composition, wherein said additional source of phosphorous is not derived from said condensed distillers solubles stream.

10. The process of claim 1, wherein an additional source of potassium is introduced to said fertilizer composition, wherein said additional source of potassium is not derived from said condensed distillers solubles stream.

11. The process of claim 1, wherein an additional source of sulfur is introduced to said fertilizer composition, wherein said additional source of sulfur is not derived from said condensed distillers solubles stream.

12. The process of claim 1, wherein an additional source of nitrogen, phosphorous, potassium, and/or sulfur is introduced to said fertilizer composition, wherein said additional source is derived from a residue associated with said starch-containing feedstock.

13. The process of claim 12, wherein said starch-containing feedstock is corn and wherein said residue is corn stover.

14. The process of claim 1, wherein said fertilizer composition is dried to produce a concentrated fertilizer composition.

15. The process of claim 1, wherein at least a portion of said condensed distillers solubles stream is dried in combination with another source of nutrient-containing solids.

16. The process of claim 1, said process further comprising recovering oil from said thin stillage stream.

17. A process for producing a distillers grains product from still bottoms obtained from milling of a starch-containing feedstock, said process comprising:
(a) providing or receiving a solids-rich still bottoms obtained from a distillation unit configured for purifying a fermentation product derived from glucose obtained during said milling;
(b) separating said still bottoms into a still bottoms solids stream and a thin stillage stream;
(c) removing a portion of the water contained in said thin stillage stream, thereby generating a condensed distillers solubles stream;
(d) recovering at least a portion of said condensed distillers solubles stream; and
(e) dewatering and/or drying at least a portion of said still bottoms solids stream to produce a distillers grains product.

18. The process of claim 17, wherein said distillers grains product contains less than about 0.4 wt % phosphorous on a dry basis.

19. The process of claim 17, wherein said distillers grains product contains less than about 0.4 wt % potassium on a dry basis.

20. The process of claim 17, wherein said distillers grains product contains less than about 0.5 wt % sulfur on a dry basis.

21. The process of claim 17, wherein said distillers grains product is a dry distillers grains product.

22. The process of claim 17, wherein said distillers grains product is a wet distillers grains product.

23. The process of claim 17, wherein step (d) comprises recovering at least a portion of said condensed distillers solubles stream as a fertilizer composition.
